(19) United States
(12) Patent Application Publication
(10) Pub. No.: US 2008/0301058 A1
(43) Pub. Date: Dec. 4, 2008

(54) Method and system for negotiating digital media licenses and distributing digital media

(75) Inventors: Scott Campbell, Atlantic Highlands, NJ (US); Gavin Robertson, Glasgow (GB); Gordon Rintoul, Hever (GB); Matthew Kennedy, Aboyne (GB)

Correspondence Address: COHEN, PONTANI, LIEBERMAN & PAVANE LLP, 551 FIFTH AVENUE, SUITE 1210, NEW YORK, NY, 10176, US

(73) Assignee: Arbinet-thexchange, Inc., New Brunswick, NJ (US)

(21) Appl. No.: 12/080,627

(22) Filed: Apr. 4, 2008

Related U.S. Application Data
(60) Provisional application No. 60/921,816, filed on Apr. 4, 2007.

(51) Int. Cl. G06Q 30/00; G06F 17/30

(52) U.S. Cl. 705/80; 707/102; 707/E17.044

(57) ABSTRACT

A method for uploading digital media and negotiating licenses, includes receiving, from a licensor, media and associated data and storing the received media and associated data in a database, generating a contract based on input from the licensor, for licensing the media to a licensee, storing the generated contract in the database of the system, and allowing the licensor and the licensee to negotiate the generated contract utilizing the system by using client applications to communicate with the system.

### CROSS REFERENCE RELATED APPLICATIONS

This application claims priority from U.S. Provisional Patent Application Ser. No. 60/921,816 which was filed on Apr. 4, 2007 the entire contents of which are incorporated herein by reference.

### BACKGROUND OF THE INVENTION

1. Field of the Invention

The present invention relates to a method and system for uploading digital media and allowing negotiation of licenses between licensors of the digital media and licensees. In particular, the licensors are owners of the digital media, i.e., independent record labels, and the licensees are suppliers, i.e., CD manufacturers or digital uploading facilities.

2. Description of the Related Art

The music recording and distribution industry includes large multinational record companies and a number of smaller record companies referred to as ‘independent record labels’. Because of the difference in the volume of materials produced, the smaller record companies experience difficulties in dealing with, for example, distributors, CD manufacturers, and digital file providers. Thus, it is difficult for electronic retailers to determine where or how to obtain a product when they receive an order from a consumer.

One solution is disclosed in U.S. Pat. No. 6,636,867, which discloses a method of enabling and administering commercial transactions using a computerized administration system. According to this prior art solution, a computer database stores records for digital media, together with records of a plurality of holders of intellectual property rights in or related to the digital media. The computer database also stores records of agreements between the holders and suppliers licensed to produce products deliverable to the consumers under the agreements.

While this solution addresses many of the problems associated with determining who owns the Intellectual Property of media produced for independent record companies, it does not provide a comprehensive package which allows uploading of the media itself to the administration system and allow negotiation of contracts by two parties.

### SUMMARY OF THE INVENTION

An object of the present invention is to provide a system for enabling commercial transactions that allows management of both licenses and content related to digital media.

In the present application and claims, ‘digital media’ includes audio and/or video content including, but not limited to, for example, albums, CDs, music tracks, movies, shows, and video shorts.

‘Client’ is a system that is used by a user to access a remote service, i.e., the system for uploading media and allowing negotiation of contracts.

‘Label’ refers to a record company.

‘Licensor’ refers to an owner of Intellectual Property rights in media who wishes to license the rights. The licensor may, for example, be a record label that products media or a company that has acquired the Intellectual Property rights in the media.

‘Licensee’ refers to a user who wishes to acquire a license to produce or distribute media.

‘Aggregator’ is a company or other entity representing a community of licensors.

The object of the present invention is met by a system for uploading digital media and allowing negotiation of licenses, including a database including product data, contract data, and user data, the product data comprising media files and metadata associated with the media files, the user data comprising information about each registered user and defines each user as one of a licensor, licensee, aggregator, and administrator, and contract data comprising information about licenses related to the media files between licensor and licensee users. The system also includes an application server, a File Transfer Protocol server, and a client application local to the client retrieves data from the database through the application server, uploads media to the database through the File Transfer Protocol server, and uploads metadata to the database through the application server.

The object of the present invention is also met by a method for uploading digital media and negotiating licenses, comprising the steps of receiving, from a licensor, media and associated data and storing the received media and associated data in a database, generating a contract based on input from the licensor, for licensing the media to a licensee, storing the generated contract in the database of the system, and allowing the licensor and the licensee to negotiate the generated contract utilizing the system by using client applications to communicate with the system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a block diagram of the system according to an embodiment of the present invention;

FIG. 2 is a schematic diagram of two-tiered users according to an embodiment of the present invention;

FIG. 3 is a block diagram of the various screens displayed to users;

FIG. 4 is a schematic diagram of screens related to products;

FIG. 5 is a schematic diagram of screens related to contracts;

FIG. 6 is a flow diagram for creating and negotiating a contract;

FIG. 7 is a schematic diagram of screens related to labels;

FIG. 8 is a schematic diagram of screens related to reports;

FIG. 9 is a schematic diagram of a client application interaction with the system of the present invention;

FIG. 10 is a schematic diagram showing the message flow for uploading media from a client;

FIG. 11 is a flow diagram for uploading media and metadata to the system of the present invention;

FIG. 12 is a schematic diagram of screens viewable by a licensee;

FIG. 13 is a schematic diagram of screens viewable by a licensor;

FIG. 14 is a schematic diagram of screens viewable by a aggregator; and

FIG. 15 is a schematic diagram of screens viewable by an administrator.

### DETAILED DESCRIPTION OF THE PRESENTLY PREFERRED EMBODIMENTS

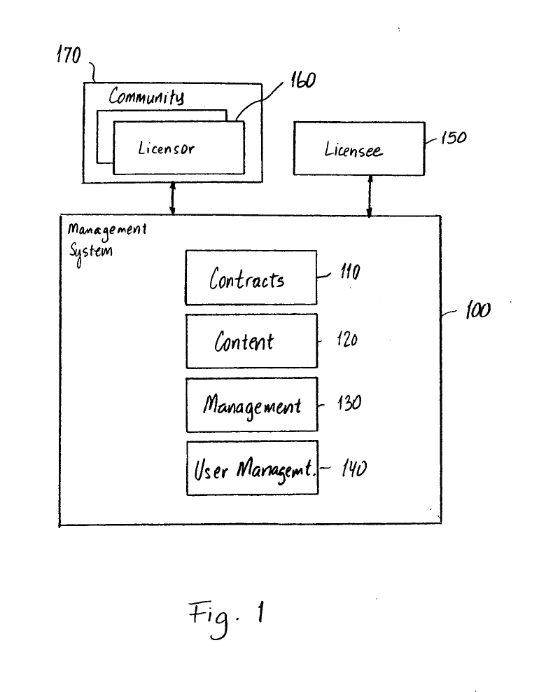

FIG. 1 is an overview of the system 100 according to an embodiment of the present invention, which includes a Contracts functional block 110, a Content functional block 120, a Management functional block 130, and a User Management functional block 140. Users access the system 100 through the Internet or other wide area network using their client systems. As shown in FIG. 1, the users of the system 100 include licensees 150, licensors 160, and aggregators 170 which represent a community of the licensors. A further user is an administrator (not shown) of the system 100. Licensors and licensees negotiate contracts through the system 100. Licensors also upload digital media content to the system and manage the content. Aggregators negotiate contracts with licensees on behalf of a group of licensors. The administrator manages the site and is typically the owner of the site.

Table 1 appended hereto shows the roles and tasks to be performed by each of the licensee, licensor, aggregator, and administrator.

The licensors, licensees, aggregators, and administrator are companies. However, individuals at the companies perform the various management tasks. The individuals may be assigned specific tasks. Thus, the users are further defined by a two-tiered structure including companies and external users. There are three types of external users including an admin user, license manger, and content manager.

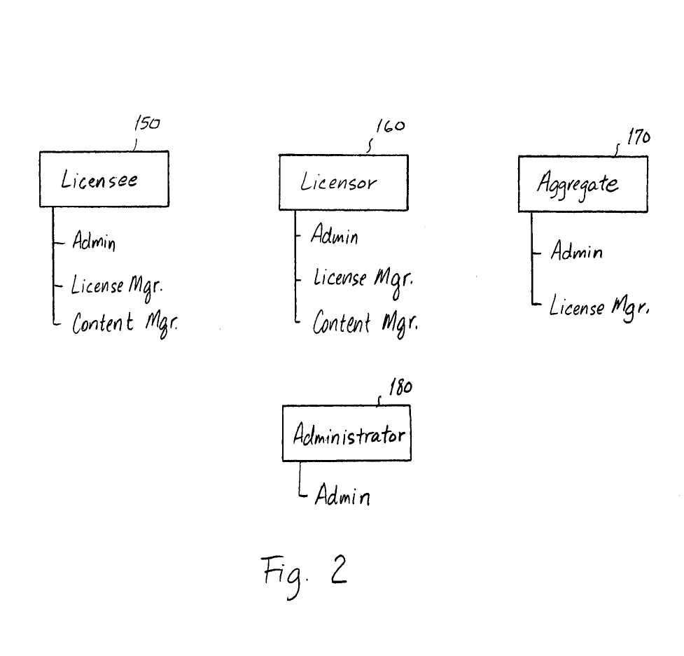

FIG. 2 shows that each licensor 160 has at least an admin user and may additionally include a license manager and a contract manager. The admin user of the licensor uploads data and performs all content related functions, creates licenses and performs functions related thereto, performs all other functions required of licensor, views all reports, make changes to company data such as company name and address. The license manager of the licensor company creates licenses and performs functions related thereto, performs all non-content-related functions, and views reports. The content manager of the licensor company uploads data and performs all other content related functions. The content manager can not perform any license-related functions and the license manager can not perform any content-related functions.

Each licensee 150 also includes at least an admin user and may additionally include a license manager and content manager. The admin user of the licensee company creates licenses and performs functions related thereto, performs all other functions required of licensor, views all reports, make changes to company data such as company name and address. The license manager of the licensee company creates licenses and performs functions related thereto, performs all non-content-related functions, and views reports. The content manager of the licensee company performs all content related functions. Neither the admin user nor the content manager of the licensee can upload data. Rather the content related functions of the licensee refer to content management which is described in more detail below.

Each aggregator 170 includes an admin user and may additionally include a license manager. Each aggregator acts on behalf of a community of licensors. The admin user of an aggregator creates licenses on behalf of all the licensors in the community and performs other license related functions, uploads data and perform other content related functions for those licensors that have allowed access to the Admin user of the community to this functionality, and makes changes to company data such as company name and address. The license manager of the aggregator creates licenses and performs functions related thereto, performs all non-content-related functions, and views reports.

The administrator 180 of the site has only an admin user which performs administration, contract, and content functions on behalf of all clients.

A plurality of database tables are used to store data used by the system 100 of present invention. For example, the tables may include a product table with information about individual products such as albums or discs, a track table with information about individual tracks of a product, a user table with information about the individual users, and a contract table with information about licenses between the users. The tables may further include cross references for cross referencing user to contracts, products to contracts, and tracks to contracts.

When a user logs into the system, the company type and the external user type of the entity that has logged in are determined based on the information in the databases. The home screen presented to the user is dynamically organized based on that determination. Some screens will only be accessible by a selected user type while others will be used by all user types with certain sections hidden or altered.

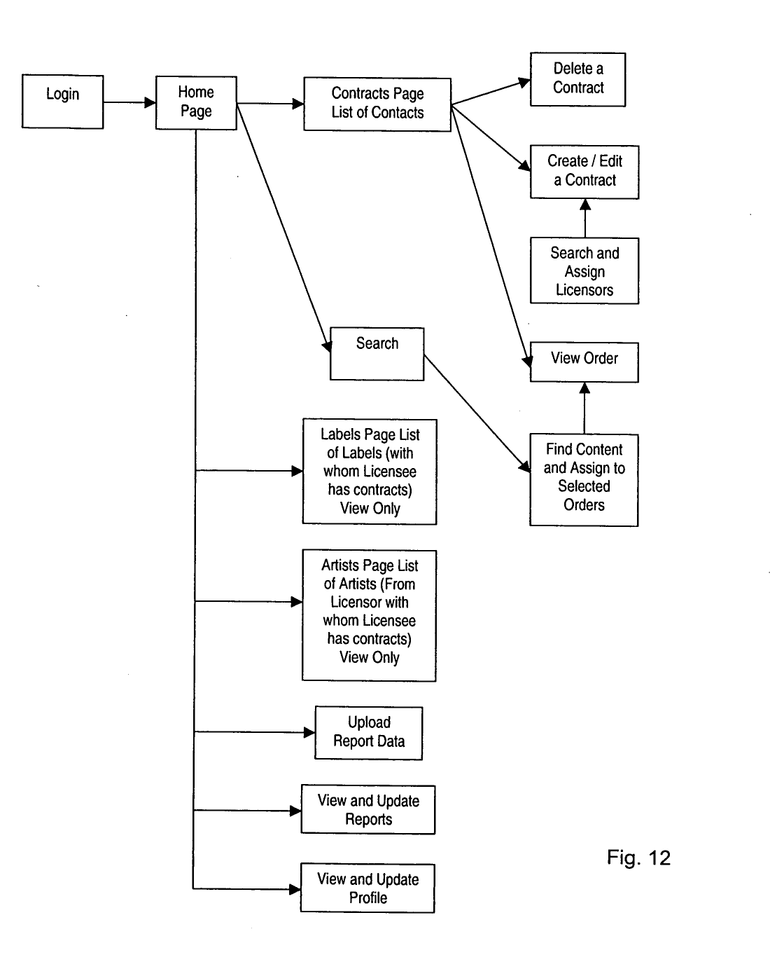

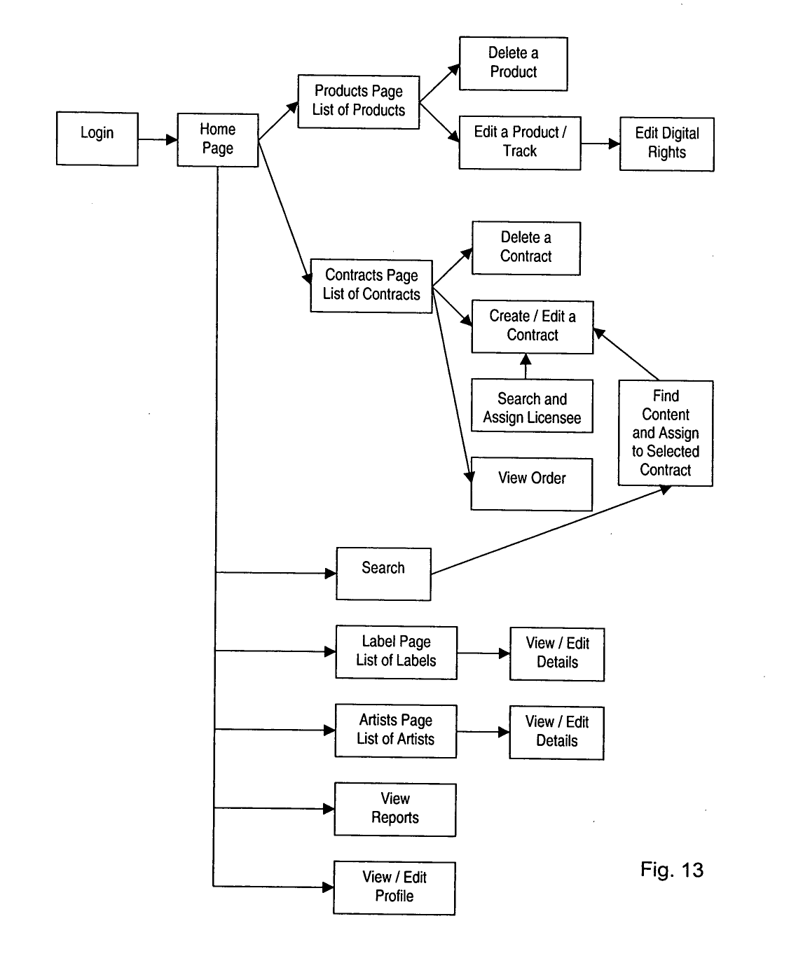

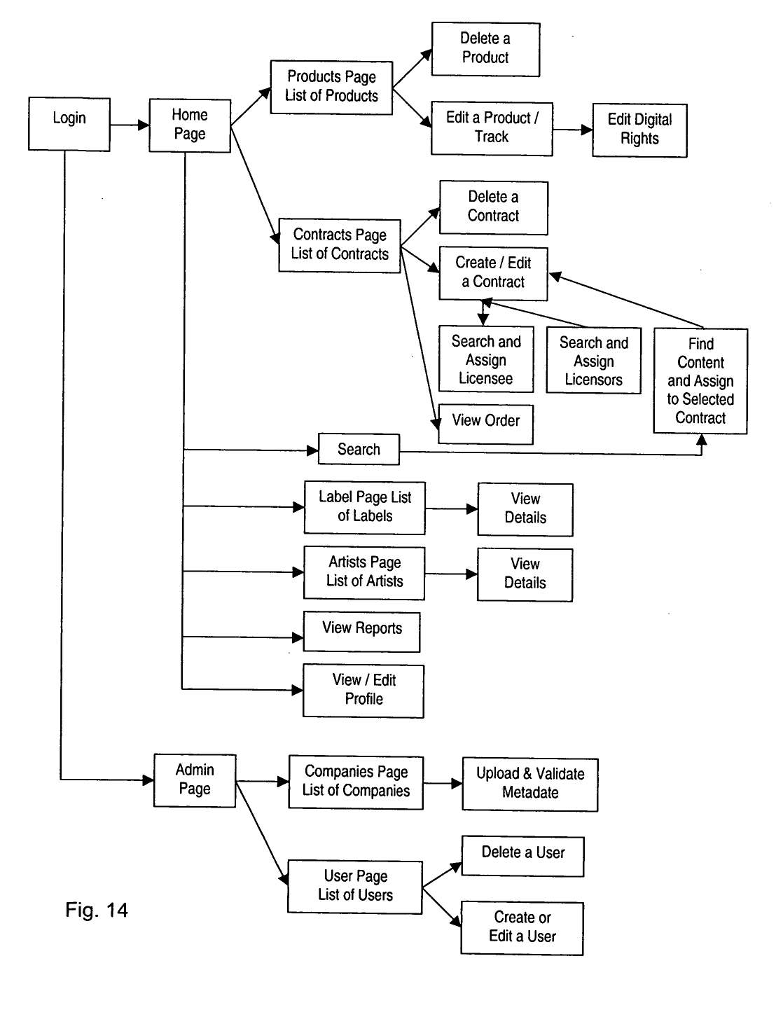

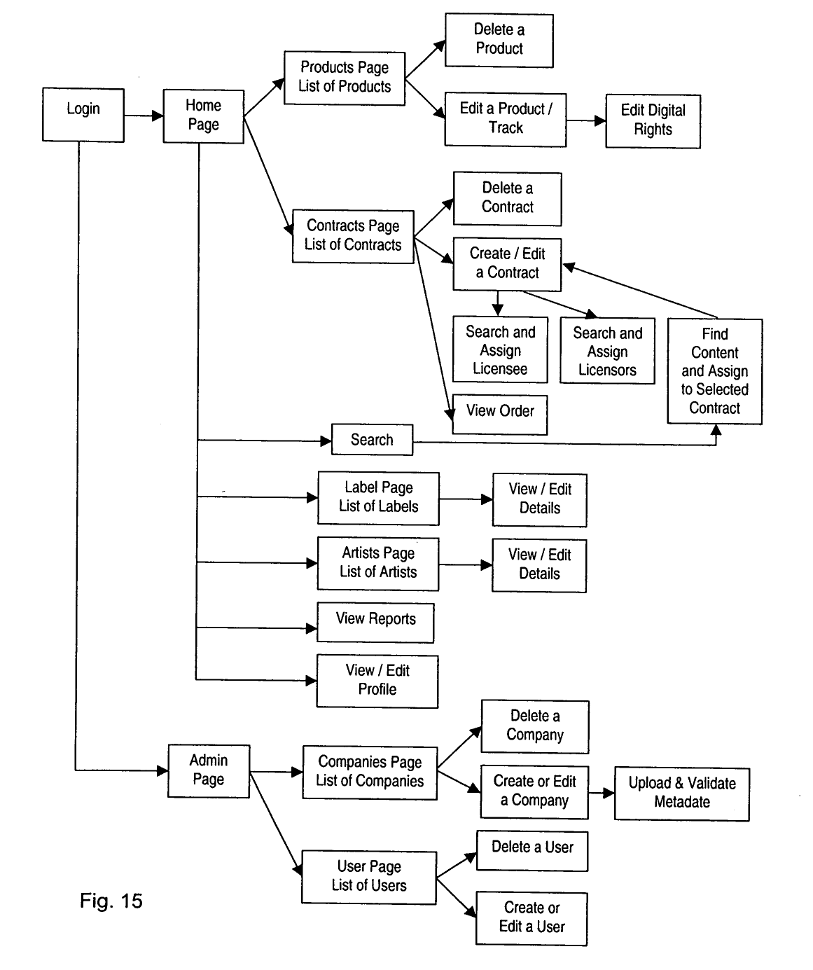

The home page includes up to six sections of information, depending on the accessibility of the logged on user. The home page will show the top 5 licensees or licensors, a content summary which refers to products in the uploading process (for licensors), a summary of processed products (for users eligible for content management), contract negotiation (for users eligible for contract management), reports containing processed billing information (for users eligible to see reports), the latest business related news. The logged on user name and/or the logo or other indication of the logged on licensor or licensee may appear on the screen of the home page. The home page may also have a product search bar. FIG. 12 shows the views available to a Licensee, FIG. 13 shows the view available to a Licensor, FIG. 14 shows the view available to an Aggregator, and FIG. 15 shows the views available to the Administrator.

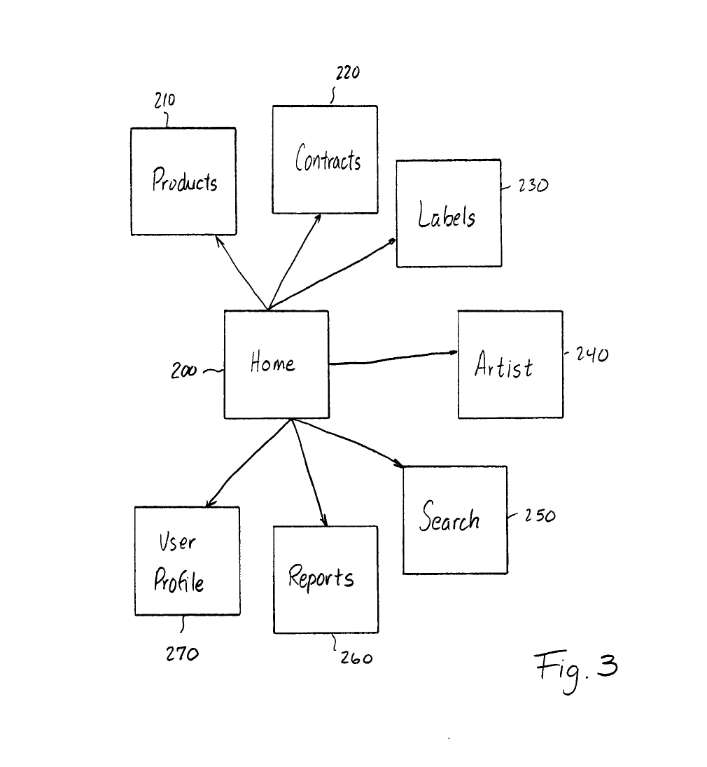

As shown in FIG. 3, when the user is viewing the home page 200, the user may select further pages such as a products page 210, a contracts page 220, a labels page 230, an artist page 240, a search page 250, a reports page 260, and user profile page 270. Each of these pages is described in more detail below.

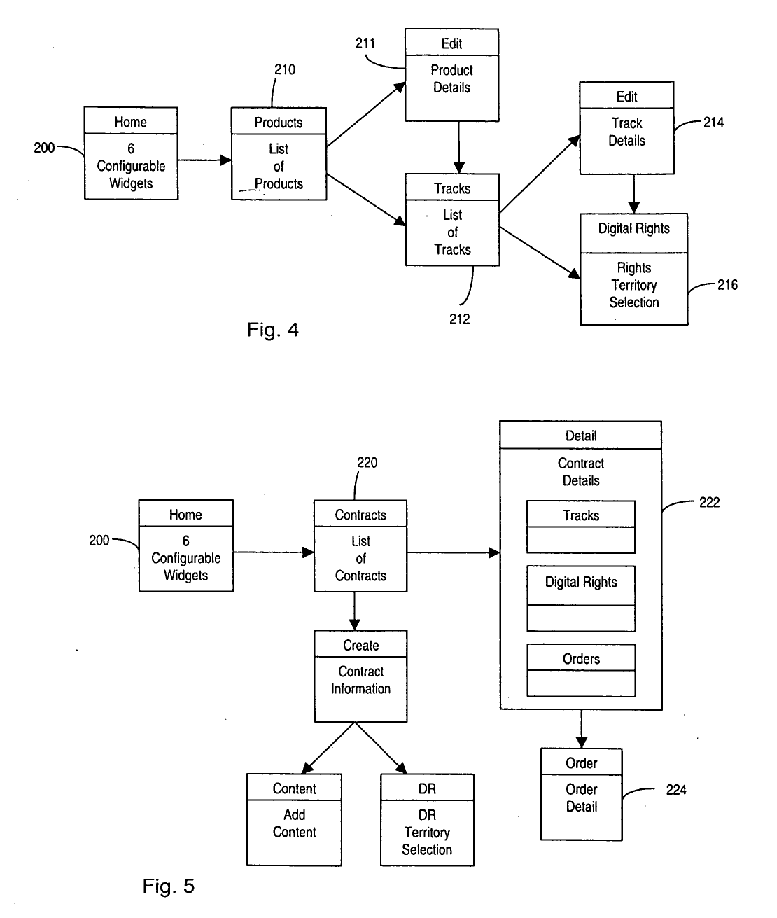

From the home page, a user may enter the products page 210, as shown in FIG. 4. This page shows a list of all products belonging to a label. The label is a recording label or independent record company. The licensor may be the label. Aggregators may select one or more labels from the list of labels in the community. The product page lists all products belonging to the selected label(s). For licensees and licensors that are head of a group, such licensors and licensees may select labels from the list of labels in the group. The list may include fields of product information which are of interest such as for example, title, artist, P-year, schedules release, number of tracks, Cat number, and UPC. Products assigned to contracts may be shown differently than those not yet assigned.

When a product is selected, a products detail page 211 is displayed which provides more details about the selected product, i.e., from an ALBUMS table. Instead of products detail, a user may select a tracks icon of a product from the products page which causes a tracks page 212 to be displayed. The tracks page shows all tracks related to corresponding product and displays a number of fields for each track, such as, for example, track name, track number, artist, duration, genre and sub-genre, and ISRC. With each track an edit icon and digital rights page is shown. Selecting the edit icon causes a tracks detail page 214 to be displayed. When the digital rights icon for a track is selected, a digital rights page 216 is displayed to determine who own the rights throughout the world or one or more regions selectable by the user, i.e., by country or region.

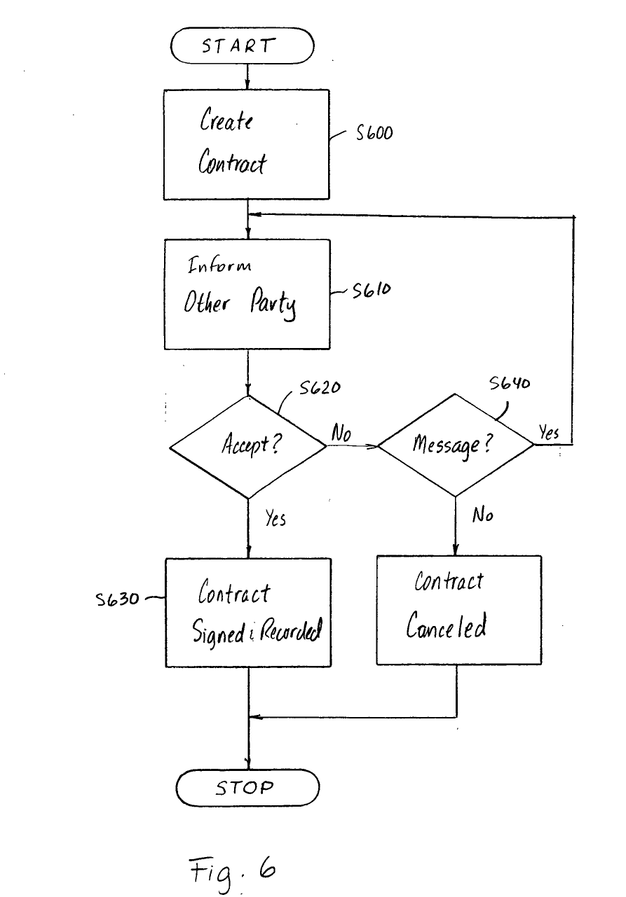

From the home page, the user may also enter the contracts page 220 as shown in FIG. 5. The contracts page 220 displays a list of all contracts belonging to a user. An aggregator user may select one or more companies within their community. Licensees or licensors that are a head of a group may select companies within the group. The contract list includes selected fields such as, for example, contract number, licensee and or licensor name, status, negotiation authority, and date. An edit/detail icon, a delete icon for signed of contracts, and additional icons for contract in negotiation. When and edit/detail icon of a contact is selected, a contracts detail page 222 is shown which provides more details about the selected contract, i.e., from a CONTRACTS table, and other associated tables, according to the following list:

The following fields should be displayed:

Contact Title

Status

Negotiation Authority

Licensee

Territories—Digital Rights

Term of Contract (Start-End)

List of Licensor—ability to delete them with a simple click

Pricing

Reporting Requirements
Frequency: Weekly/Monthly/Twice Monthly/Quarterly/On-demand;
Format: CSV/XML/XLS;
Delivery: email/ftp/http;

Payment Requirements
Frequency: Monthly/Quarterly;
Currency: US $/UK Pound/Canadian $/Australian $/Japan Yen/New Zealand $;
Method: Check/Bank Wire/PayPal

Technical Requirements
Encoding:
   Format: WMA/MP3/MC/WAV/REAL/Audio/AIFF/SD2;
   DRM: Yes/No; Type: Window/
   Bit Rate: 28.8/56.6/96/128/196/256/320 lossless;
Cover Art:
   Size: in PIX & dpi,
   File format: JPG/TIFF/EPS

Use:
Download: Internet/Mobile
Streaming: Internet/Mobile;
Ring tone: Yes/No;
Master tone: Yes/No;
Transfer to device: Yes/No;
Burn to CD: Yes/No

Button—Request additional clause.

From the contracts detail page 222, the user can also select tracks, which provides a summary of tracks associated with the contract, digital rights territories, which provides a summary of digital rights territories, and a summary of orders. The tracks detail page 212 and digital rights page 216 are as described above. The order page 224 displays a list of order including order/title number, status, order date, and order type. Along side each order is a detail icon. Selecting this icon shows all tracks associated with the order.

From the contracts page, a user may also select Create Contacts page 226. The layout of this page is the same as the Contracts detail page. However, the status field is set to ‘draft’, the licensor/licensee field is set to the name of the user's company and digital rights is set to ‘world’. From this page, the user changes territories and adds content. The Change Territories page 228 is the same as the digital rights page described above. In the add content page 229, the system selects all products that belong to the licensor and meet the digital rights requirements set up in the contract (and those that partially meet the requirements). The user can select products to include in the contract.

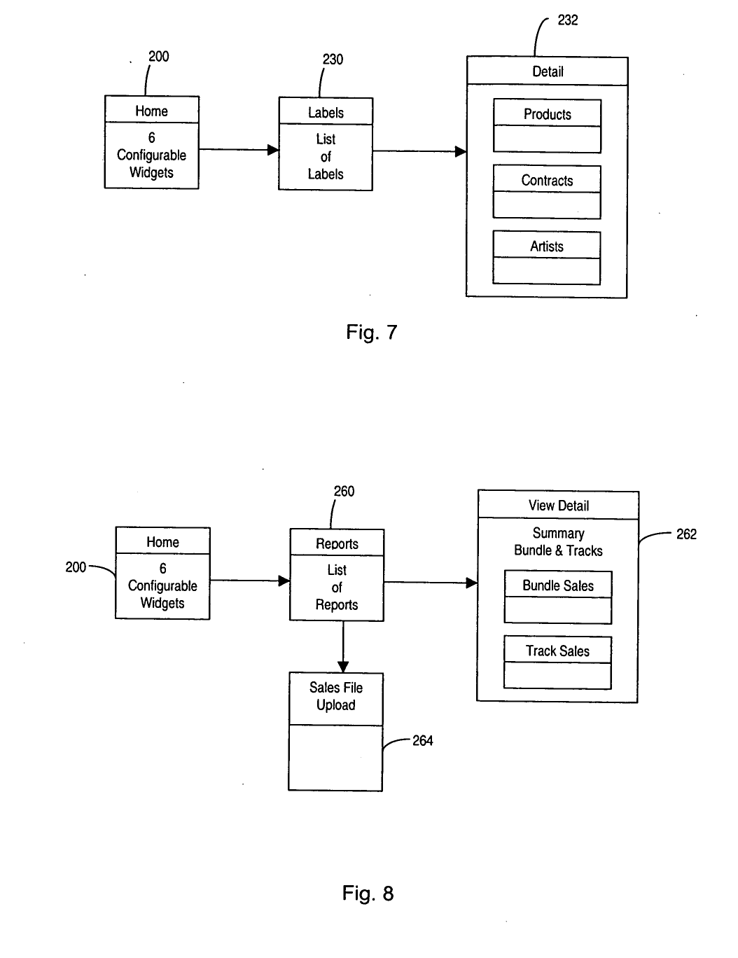

After the product selection is completed on the Create Contracts page 226, the user initiates Contract negotiation process which is shown in FIG. 7. According to the process, a user first creates the contract using the Create Contacts page as described above, step S610. The system generates a message to the other party to the contract which informs the other party that the contract is available for their review, step S610. When the other party logs on, they receive the message and the contract is put in the negotiation state in which the other party decides whether to accept, step S620. When the other party accepts or rejects, a message may be sent to the owner of the contract. When the other party accepts, the system places the contract in a signed off state, step S630. The other party may offer suggest changes instead of accepting, step S640. If the contract owner agrees, the owner can send an acceptance back in which case the contract is signed-off and process closed. This can continue for a few cycles. A time limit for action by a party, wherein the contract is canceled and the process closed if there is no action, step S650.

From the home page 200, a user may also select the labels page 230, as shown in FIG. 5. If the user belongs to a company that has a group of labels or if the user is an aggregator, this page will list all the companies in the group or community by company name, contact name, email address. Each company will also be associated with edit detail, and delete icons. The details page 232 will allow users to view contact, products and artists sub-pages for a selected label. The contracts and products pages are described above and the artists page is described below.

From the home page 200, a user may also select the artists page 240. This page displays a list of artists belonging to a licensor. Aggregators may select one or more licensors from the list of licensors in their community. For licensors that are head of a group, such licensors may select licensors from the list of licensors in the group. The list includes Artist Name, Artist Type, Artist Role and includes edit, detail, and delete icons for each artist. The details icon opens an Artists detail page which shows products by the artist. The products may be listed in accordance with the products page described above.

From the home page 200, the user may select the search page 250 which allows the user to search in products, contracts, labels, by upload date, territory and use, artist, product name, album UPC, track name, track International Standard Recording Code (ISRC), genre and style, explicit lyrics, whether included in contract, release date. The result page can be sorted be clicking on each heading such as for example, title, artist, tracks, upload date. Along each line, a detail icon is displayed, selection of which produces a product, artist, contract or track detail page as described above.

From the home page 200, the user may further select a reports page 260, as shown in FIG. 6. This page lists reports for a licensee or licensor. The following fields are displayed for each report; licensor name, licensee name, report date, report period. Each report listed has three icons for view, delete, and export. The export icon can be divided or have further buttons for export format such as CSV, XM1 and X1S. For licensees, an icon for upload sales data is provided. Selecting the view icon causes a reports view detail 262 to be displayed. The reports view includes the following information:

The title line has the following information:

Licensor Name

Licensee Name
Report Month

Report Period—Start and End

Report Currency

Followed by a line of Bundle Summary that displays the following information:

Currency

Bundle Gross

Bundle Net

Bundle Share

Report Bundle Gross

Report Bundle Net

Report Bundle Share

Bundle Volume

Followed by a line of Track Summary that displays the following information:

Currency

Track Gross

Track Net

Track Share

Report Track Gross

Report Track Net

Report Track Share

Track Volume

The next section should display Bundle Sales—the following information is shown per line.

Bundle Name

Catalog Number

Artist Name

UPC

Country

Price Tier

Unit Price

Currency

Total Volume

Total Gross

Total Net

Total Share

The next section should display Track Sales—the following information is shown per line.

Track Title—link to track details

Artist Name

ISRC Code

Product Name

UPC

Country

Price Tier

Currency

Total Volume

Total Gross

Total Net

Total Share

The upload sales file 264 has the fields of report name, report date, report period, file type, and browse button.

The home page 200 may also have an icon for the user profile page 270 which includes data from a USER database. The user profile page allows admin users to view, change or update the information.

The Administrator further has access to Admin pages including a Registration page, a Companies page, and a Users page.

A company, i.e., licensor, licensee or aggregator, that wishes to use the system, must register with the system. The home page 200 includes a view license agreement link. After an unregistered user reads the agreement and clicks accept, the server presents a form to be filled out, i.e., registration page. Once the system accepts the requested information, the administrator begins the registration process and sends a message to the user upon completion. The user name and temporary password are sent to the user and the account is activated.

The Administrator also has access to a Companies page which lists all the companies in the system. The Administrator can select Edit, Details, or Delete icon for each listed Company. The selection of each icon switches to a Edit, Details or Delete page which is the same for a selected company. Create and Edit pages allow the contents to be changed. The Administrator may upload all metadata for music that a licensor has produced. This information may for example, delivered through an excel sheet.

The Administrator can also enter a User Page from the Homepage which displays a list of all the users showing identity data. Each user is associated with an edit, details, and delete icon. The selection of an icon cause the view of the switch to an Edit, Details, or Delete page, each of which is the same and lists User details, from the USER table.

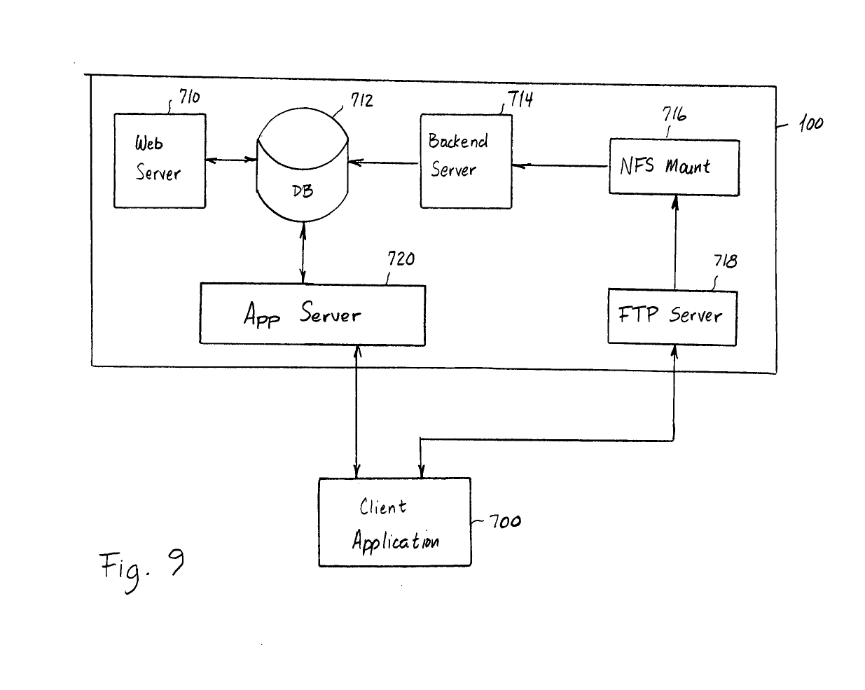

Referring to FIG. 9, a further embodiment of the present invention discloses that the system 100 interacts with a client application to allow the client to retrieve data from the system, upload the media content to the system database, and upload metadata to the system database. At the user end, a client application 700 is associated with hardware capable of CD ripping and/or reading music/video files of various formats. The application 700 also supports reading of artwork from files and/or scanners. The client application 700 is deployed with a single click over the network using, e.g., Java Web Start technology.

A webserver 710, database 712, backend server 714, Network File Server (NFS) mount 716, File Transfer Protocol (FTP) Server 718 and Application Server (App server) 720 are arranged at the system. The client application 700 is arranged at the client end. The client application 700 retrieves data from the database 712 through the App server 720 using web services (described in more detail below), uploads media to the NFS mount 716 through the FTP server 718, and uploads metadata to the database 712 through the App server 720 using web services. The backend server 714 periodically reviews the media files that are newly uploaded and establishes a relationship between these uploaded files and the corresponding metadata stored in the database 712.

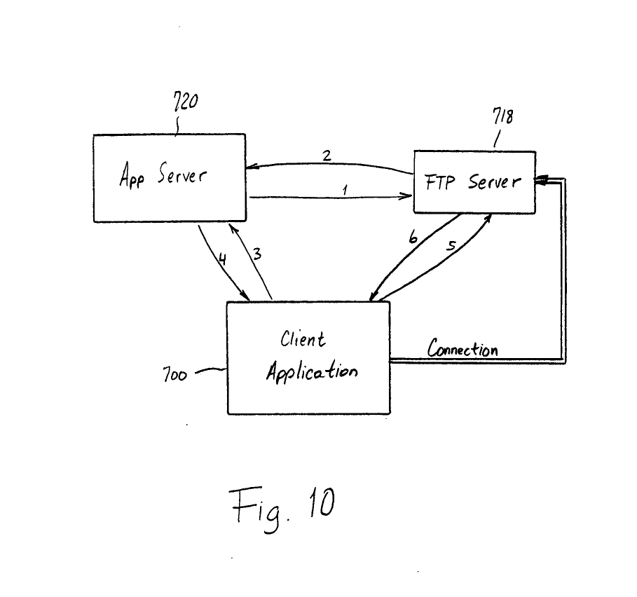

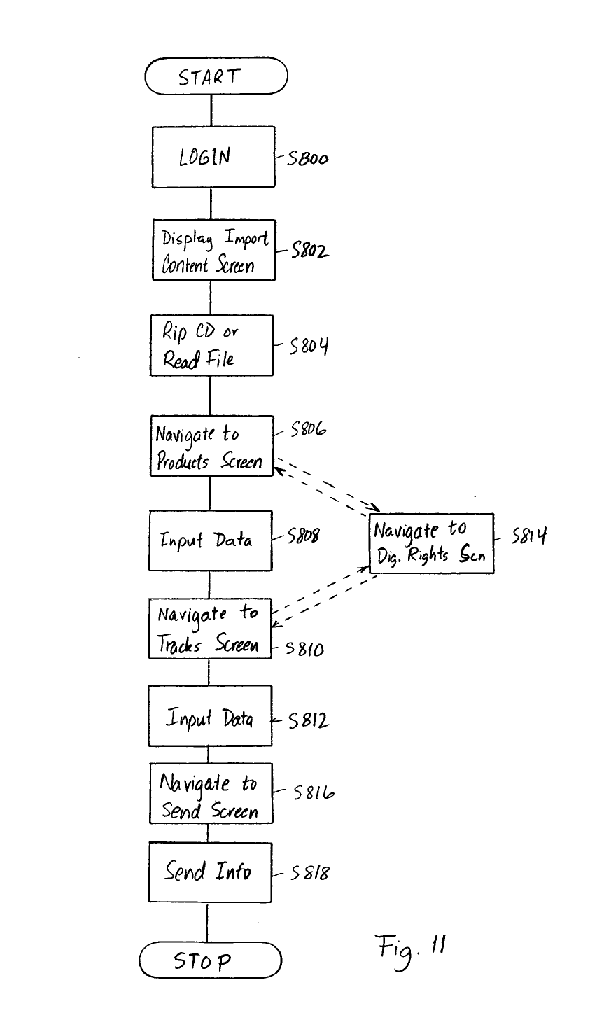

FIG. 10 is a schematic diagram showing FTP connection workflow between the client application 700, the App server 720 and the FTP server 718. The App server first asks the FTP server for the next password. The FTP server then sends the nest password to the App server. The client application calls the App server for and FTP start and the App server responds with the password. The client server then requests a connection to the FTP server with the password provided by the App server and the FTP server responds affirmatively and opens a connection.

As mentioned above, web services are used by the client application to communicate with the system. The web services allow the client or user to login, get and save data from the database, and initiate upload of media. The following describes some web services which can be used for the above-stated purposes. However, these web services are merely examples. Other web services may additionally or alternatively be used.

An Authentication web service receives a username and password as inputs and checks if the username and password combination has a valid entry in the USERS table in the database and also checks if the is_Licensor OR is_Total_Admin AND is_Activated flag is on in a USER_RIGHTS table for the given user.

A GetLabelNames web service receives a userid as an input and uses the userid to find all entries in a User2Label table and returns a list of label names. If the Role of the given entry is set to Admin, this web service adds the corresponding Label name to the list.

A GetArtistForLabel web service receives and userid and label as inputs and uses the userid to find all entries in the User2Label table. If the Role of the given entry is set to Admin, and the Label name is the same as the given label, then this web service returns ARTIST_NAME and ARTIST_TYPE from an ARTISTS table and corresponding ARTIST_ROLE from the ARTIST_JOIN table for all artists for the given label.

A SendMetaData web service receives userid and XML documents as an input and transfers XML documents to the App server. All products related information is stored in the ALBUMS table and all tracks related information is stored in a TRACKS table. To store Digital Rights for a track, the web service converts territory information into bit mask fields. Territory information is stored in the database in 8 32-bit mask fields. Each bit in these fields represents a separate country, i.e., each country has its own unique single bit mask as shown below:

| | BITS | | | | | | | | |
|---|---|---|---|---|---|---|---|---|---|
| | 31 | 30 | 29 | 28 | . . . | 3 | 2 | 1 | 0 |
| Afghanistan | 0 | 0 | 0 | 0 | | 0 | 0 | 0 | 1 |
| Albania | 0 | 0 | 0 | 0 | | 0 | 0 | 1 | 0 |
| Algeria | 0 | 0 | 0 | 0 | | 0 | 1 | 0 | 0 |
| . . . | | | | | | | | | |

32-bits was selected, as this length is compatible with the largest number of hardware and software platforms. 8 32-bit fields allow 256 combinations to be stored—much more than approximately 180 countries of the world.

GetProductsWoService web service receives userid and labelname as inputs and uses the userid and labelname to find the appropriate label in the USER2LABEL table. For all products for that label in the album table, this web service finds those that do not have any tracks in a CONTRACT2TRACK table and returns a list of products.

GetAvailLicensees web service receives a userid as input and uses the userid to find the list of contracts where the userid is the same as the licensor id in the CONTRACTS table. The licensees are selected from this list and the web service then creates and returns a list of licensee names using the USER table.

SaveSelectLicenseeProd web service receives userid, listofproducts, licenseenames as inputs and uses the CONTRACTS table. Where the userid is the same as the licensor id and wherein licensee name is the same as the Licensee_name, the CONTRACT2TRACK record is created with the appropriate information for each track.

DeliverSelectLicenseeProd web service receives userid, listofproducts, licenseenames as inputs and uses the CONTRACTS table. Where the userid is the same as the licensor id and wherein licensee name is the same as the Licensee_name, a CONTRACT2TRACK record is created with the appropriate information for each track, a CONTRACTORDER record is created with the appropriate information, and an ORDER2TRACK record with appropriate information is created for each track.

StartFTP web service receives userid and productid as inputs and is called before the start of an upload of a media product. This web service creates a correlation between metadata and media of a given product. It stores the location where the product and tracks are stored in ALBUMS and TRACKS table and writes a checksum to the TRACKS table.

EndFTP web service receives userid and productid as inputs and is called at the end of a media upload. It determines if upload was successful or failed and sets sent_flag for each track in TRACKS if tracks were successfully loaded and sets sent_flag in the ALBUMS table if all tracks were successfully uploaded.

FIG. 11 shows a method for uploading content. At a first step, S800, a user connects to the system and is presented with a login screen. The user enters a username and password and the system verifies the username and password using the Authentication web service, step S802. If the authentication passes, the user is allowed to use the application.

The user must enter a 3-character Label code and a maximum 20-character Catalogue number for the media to be uploaded. The client application then rips one or more CDs or reads files, step 804. While Ripping CDs, track number, artist name and time should be populated into Audio CD table. This is accomplished by accessing CD DB or Free DB. When such information is not available, the Track Name field should show track1, track2, track3, etc., artist name would remain blank and the Time field should be a calculated with some approximation. Clicking on the Import button moves the contents of this table to the Product table.

While files are read in step S804, track number, artist name and time should be populated into Files table. When tracks are imported—clicking the Import button—the disc number appearing in the Disc field under Product is same as the one showing in Disc X of X. The user could mix tracks from ripped CDs with files.

When a track is deleted under the Product area, all tracks below the deleted track are adjusted to contiguous track numbers.

The user can enter a filename or click the Browse button to select an artwork file from the file system to be associated with the media.

After selecting the artwork, if any, the user navigates to the Product screen, step S806 and inputs product data, step S808. The system carries over the catalog number and number of discs from the previous screen and displays it on the title. The GetLabelNames web service retrieves names of labels to be displayed in the drop down list for the Record Label field. The Artist selection screen is a complex list. The system gets the list of artists from the server using the GetArtistForLabel web service. The system displays this list along with their type that could be—Artist or Band- and lets the user select the Role from a choice of—Main or Other. If the artist name doesn't appear in the list, the user has the option to add a new name using the edit box provided at bottom of the list. The user would have to provide the Role and select the Type as well. Whatever value the user selects for Genre, sub-Genre and Price Tier, the same values are set for all tracks for this product. However, the user is allowed to change these vales at the Track level. All other fields are user entry.

If the user checks the Are you the publisher check box, the Publisher field of this product's tracks is populated with the label name and the fields are un-editable.

The user then navigates to the Tracks screen, step S810. It is also possible for the user to navigate back to the Import screen by using a PREVIOUS icon or button. If the user decides to move to the previous screen, the data entered in the Products screen is not be discarded.

The track screen displays the product name from the previous screen and display it on the title of the screen. The use then inputs the track data, step S812. The Record Label field is displays the label name and is display only. The grid is populated with the track information. The Preview Start field has a default valve of 30 on entry to this screen and some of the other fields in the grid might be blank. All fields on this screen act on the track selected (highlighted) in the grid. The user can change the order of the track by moving it up or down in the list. The track numbers are reordered. The user may also assign a track a different disc number. Genre, sub-Genre and Price Tier fields are set based on the values of the Product but user is able to change these values for each track. All other fields are either user entry or drop down lists similar to the Product screen. Publisher, Arranger, Composer and Lyricist have an Apply All button next to them. By pressing this button the user can apply these values to all tracks. However, the user can still change these values in individual tracks. The Publisher field is non-editable if the ‘Are you the publisher’ check box is selected by the user in the Product screen. In that case, this field displays the name of the label. The Digital Rights field also has an Apply All button next to it and acts the same way as described above.

From both the Product and Tracks screens, the user can navigate to the digital rights screen, step 814. When the Digital Rights screen is displayed, its title indicates from where it was invoked. It has three sections—world, regions and countries. If the user selects World, the other two sections become inactive. The user is able to select multiple regions and countries simultaneously. In the countries section, most common countries are listed in alphabetical order before the other countries are listed. The list of most common countries is provided below. A CANCEL button will close the window and return without applying the changes. An APPLY button will apply the changes close the window and return.

After inputting the track data, the user navigates to the Send screen, step S816. The user may optionally navigate to a previous screen, i.e., the products screen. If the user decides to move to the previous screen, the data entered is NOT discarded.

The user sends the data, step S818. The send screen displays the product name and has three sections—Metadata, Media and Logs. The user can just send metadata by pressing the Send Metadata button, which sends metadata and closes the window. The user may upload media of multiple products whose metadata has already been sent. Uploading media automatically sends metadata, if it has not already been sent. To send media, the application uses the StartFTP web service to open the FTP connection with the FTP server. The details of this interaction are described above. Once the connection is opened, it should monitor each track of every product selected by the user. As the product is uploaded, the Logs section shows the progress of upload with log messages. When all Tracks related to a product are successfully uploaded the Status field for the given product in the Media section of the screen shows—Upload Completed. When all products are uploaded successfully, the Logs show—x products successfully uploaded. If the upload encounters any problems, the Logs describe the problem and retry button can be activated. When Retry button is clicked, the upload should restart from the last track that failed to upload successfully.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

TABLE 1

| Tasks | Licensor | Licensee | Aggregator | Admin |
|---|---|---|---|---|
| Contract Management | | | | |
| Create a new contract | Yes | Yes | Yes | Yes |
| List all Contracts | No | No | No | Yes |
| Entered (your own) and | Yes | Yes | Yes | Yes |
| offered (to you) | | | | |
| Contracts | | | | |
| Delete own contracts | Yes | Yes | Yes | Yes |
| Select Community | No | No | Yes | Yes |
| Select Licensee | Yes | No | Yes | Yes |
| Add Licensors | No | Yes | Yes | Yes |
| Add Terms of | Yes | Yes | Yes | Yes |
| Contract | | | | |
| Add Pricing | Yes | Yes | Yes | Yes |
| Add Reporting Require- | Yes | Yes | Yes | Yes |
| ments | | | | |
| Add Payment Require- | Yes | Yes | Yes | Yes |
| ments | | | | |
| Add Tech Requirements | Yes | Yes | Yes | Yes |
| Add Addendums | Yes | Yes | Yes | Yes |
| View Contract | Yes | Yes | Yes | Yes |
| Select Content for | Yes | No | Yes* | No |
| a contract | | | | |
| View own Orders | Yes | Yes | Yes* | Yes |
| View others' Orders | No | No | For the | All |
| | | | Community | |
| Create test Orders | No | No | No | Yes |
| Create own new track | Yes | Yes | Yes* | Yes |
| orders | | | | |
| View Catalog and add | Yes | Yes | Yes* | Yes |
| content to an order | | | | |
| Accept or reject a | Yes | Yes | Yes* | Yes |
| contract | | | | |
| Content Management | | | | |
| Update Metadata | No | No | No | Yes |
| Update unassigned Meta- | Yes | No | Yes* | Yes |
| data | | | | |
| Select unassigned Meta- | Yes | No | Yes* | Yes |
| data | | | | |
| Assign Metadata to | Yes | No | Yes* | Yes |
| contracts | | | | |
| Search and Browse | Yes | Yes | Yes | Yes |
| content | | | | |
| Tag content | Yes | Yes | Yes | Yes |
| Save content to an | Yes | Yes | Yes | Yes |
| order | | | | |
| Generate and preview/ | Yes | Yes | Yes | Yes |
| text XML | | | | |
| Can view own reports | Yes | Yes | Yes | Yes |
| and stats | | | | |
| General | | | | |
| Change own company's | Yes | Yes | Yes | Yes |
| name and address | | | | |
| Change other company's | No | No | Yes* | Yes |
| name & address | | | | |
| Can modify company | No | Yes | No | No |
| sales data for reports | | | | |
| Can view own reports | Yes | Yes | Yes | Yes |
| and stats | | | | |
| Admin | | | | |
| Create a new Company | No | No | No | Yes |
| Delete a Company | No | No | No | Yes |
| Format Configuration for | No | No | No | Yes |
| Licensee | | | | |
| Test Configuration of | No | No | No | Yes |
| Licensee | | | | |
| Create a user | No | No | Yes** | Yes |
| Delete a user | No | No | Yes** | Yes |
| Validate contents of | Yes | No | Yes* | Yes |
| Excel | | | | |

*For those Licensors for whom the Admin_flag is set in a COMMUNITIES table. By default the community flag should be set on creation configuration of company within a community.
**For all users within the Community.

What is claimed is:

1. A system for uploading digital media and allowing negotiation of licenses, comprising:
a database including product data, contract data, and user data, the product data comprising media files and metadata associated with the media files, the user data comprising information about each registered user and defines each user as one of a licensor, licensee, aggregator, and administrator, and contract data comprising information about licenses related to the media files between licensor and licensee users;
an application server;
a File Transfer Protocol server; and
a client application local to the client retrieves data from the database through the application server, uploads media to the database through the File Transfer Protocol server, and uploads metadata to the database through the application server.

2. The system of claim 1, wherein client application allows negotiation of pending contracts saved in the database by the licensee, licensor, and aggregator users utilizing the client application and web services.

3. A method for uploading digital media and negotiating licenses, comprising the steps of:
receiving, from a licensor, media and associated data and storing the received media and associated data in a database;
generating a contract based on input from the licensor, for licensing the media to a licensee;
storing the generated contract in the database of the system; and
allowing the licensor and the licensee to negotiate the generated contract utilizing the system by using client applications to communicate with the system.

4. The method of claim 3, wherein the step of allowing comprises, allowing the licensee to accept the generated contract, and allowing the licensee to change the generated contract and request acceptance of the changed contract from the licensor.

5. The method of claim 4, further comprising the steps of associating the media with generated contracts and storing the associations.

6. The method of claim 5, wherein the parties to the signed-off contracts are stored with the contract information.

7. The method of claim 5, further comprising the step of storing, by the system, sales information for the media.

8. The method of claim 5, further comprising the step of allowing licensees and licensors associated with the stored media to modify product data associated with the stored media.

9. The method of claim 5, further comprising the step of allowing a licensee to view a list of record labels associated with licensors with whom the licensee has recorded contracts, view artists from licensor with whom licensee has contracts, upload report data, and view and update reports.

10. The method of claim 5, further comprising the step of allowing a licensor to view a list of products associated with the licensor, view and edit a list of contracts associated with licensor, view a list of record labels associated with the licensor, view artists associated with the licensor, and view reports.
